(19) United States
(12) Patent Application Publication
(10) Pub. No.: US 2024/0392563 A1
(43) Pub. Date: Nov. 28, 2024

(54) SUPER-COMPRESSIBLE METAMATERIAL CONCRETE AND METHOD FOR MAKING SAME

(71) Applicant: UNIVERSITY OF PITTSBURGH - OF THE COMMONWEALTH SYSTEM OF HIGHER EDUCATION, Pittsburgh, PA (US)

(72) Inventors: Amir Alavi, Pittsburgh, PA (US); Kaveh Barri, Pittsburgh, PA (US); Lev Khazanovich, Sewickley, PA (US); Jake Kline, Kinnelon, NJ (US); Qianyun Zhang, Pittsburgh, PA (US)

(21) Appl. No.: 18/693,092

(22) PCT Filed: Sep. 19, 2022
(86) PCT No.: PCT/US22/44016

§ 371 Date: Mar. 18, 2024

Related U.S. Application Data
(60) Provisional application No. 63/245,300, filed on Sep. 17, 2021.

(51) Int. Cl. E04B 5/43; C04B 24/28; C04B 28/04

(52) U.S. Cl. CPC E04B 5/43; C04B 24/282; C04B 28/04

(57) ABSTRACT

A metamaterial, comprising: an auxetic lattice structure with snap-through buckling behavior comprising a plurality of rows; wherein the lattice defines a holey arrangement array; and cement, concrete or any other brittle materials disposed in the auxetic lattice structure.

### RELATED APPLICATION

This application claims priority benefit under 35 U.S.C. § 119(e) of U.S. Provisional Application No. 63/245,300 filed Sep. 17, 2021 the contents of which are herein incorporated by reference.

### FIELD OF THE DISCLOSURE

### Technical Field

The present disclosure generally relates to the field of mechanical metamaterials, concrete and cementitious material fabrication methods.

### Background

The present disclosure presents a new class of lightweight reinforced composite concrete materials with unprecedented compressibility and mechanical tunability. The present disclosure presents the striking concept of “metamaterial concrete” by harnessing the power of metamaterial systems to fabricate self-recovering concrete structures. The preferred metamaterial concrete systems of the present disclosure comprise reinforcement auxetic polymer lattices with snap-through buckling behavior fully embedded inside a concrete matrix. Preferred concrete metamaterials have been built with different geometries and reinforcement levels. Experimental and numerical studies have been conducted to investigate the mechanical properties of the preferred concrete metamaterials of the present disclosure, which highlight the potential of such preferred concrete metamaterials to transform the current design practice in concrete industry.

Concrete is the most utilized material in the construction industry. It is eyed favorably in construction due to fast-developing compressive strength, easiness to shape, and low cost to weight ratio. Those very same advantages of concrete are matched with some serious long-term issues in its post-construction lifetime. Concrete performs poorly in tension to the magnitude that it performs well in compression. Its extreme brittleness increases vulnerability to weathering and fatigue effects. Massive amounts of time and research have been dedicated to improving concrete properties by changing either the mixture recipe or the reinforcement method [1-5]. The commonality between these studies is to fundamentally change concrete behavior to increase ductility. A ductile material can deform plasticly upon yielding and maintain functionality, whereas a brittle material such as concrete will fail immediately at yield. Ductility can increase the concrete materials capacity in any loading condition, most importantly bending, compression, and tension for structural applications. Changing mixture properties has shown to be effective in increasing compressibility [1], whereas reinforcement bolsters flexural capacity [3]. However, a next technological revolution in this arena is arguably creating a new generation of concrete materials that offer compressibility and mechanical tunability simply via a rational architectural design. This goal can be potentially achieved using the architected mechanical metamaterial concepts. Mechanical metamaterials are artificial material with engineered micro/nano-scale structures to provide unprecedented mechanical properties [6]. There has been a growing interest in exploring various aspects of metamaterials for engineering applications in recent years [7]. While most of the studies in the area of metamaterial are focused on designing micro/nano-scale structures [8], a major challenge ahead of the metamaterial science is how to adopt them for large/mega scale applications, in particular in construction industry.

According to the present disclosure, the concept of “metamaterial concrete” will comprise a new class of lightweight reinforced composite concrete materials with dramatic compressibility and mechanical tunability. To this aim, the present disclosure introduces preferred mechanical metamaterial design approaches into the fabrication of concrete structures. In preferred concrete metamaterials of the present disclosure, auxetic polymer lattices embedded inside the concrete matrix serve as reinforcement elements. The present disclosure further encompasses preferred self-recovering snapping concrete metamaterials and describes preferred material geometries, concrete mixture proportions, and testing results. Potential groundbreaking applications of preferred concrete metamaterials of the present disclosure are described to further accentuate the full capabilities of such concrete metamaterials in commercial construction.

### BRIEF SUMMARY OF THE DISCLOSURE

In a preferred aspect, the present disclosure comprises a metamaterial, comprising: an auxetic lattice structure with snap-through buckling behavior comprising a plurality of rows; wherein the lattice defines a holey arrangement array; and cement, concrete or any other brittle materials disposed in the auxetic lattice structure.

In another preferred aspect of a metamaterial of the present disclosure, the auxetic lattice structure comprises a polymer.

In a further preferred aspect of a metamaterial of the present disclosure, the auxetic lattice structure comprises a thermoplastic polyurethane.

In another preferred aspect of a metamaterial of the present disclosure, each row of the auxetic lattice structure defines a channel or conduit in which the cement, concrete or any other brittle materials are disposed.

In an additional preferred aspect of a metamaterial of the present disclosure, each channel or conduit has an open side or end for receiving the cement, concrete or any other brittle materials.

In another preferred aspect of a metamaterial of the present disclosure, each row defines one or more curved sections.

In yet another preferred aspect of a metamaterial of the present disclosure, the each row defines a plurality of curved sections.

In another preferred aspect of a metamaterial of the present disclosure, the cement or concrete comprises a mixture of Type I/II Portland cement and water.

In yet another preferred aspect of a metamaterial of the present disclosure, a maximum water to cement ratio of 0.45.

In another preferred aspect of a metamaterial of the present disclosure, the compressibility of the metamaterial is varied by varying the Young's Modulus and/or Poisson's Ratio of the auxetic lattice structure and/or the cement or concrete.

In a further preferred aspect of a metamaterial of the present disclosure, the metamaterial does not exhibit transverse strain under compression.

In another preferred aspect of a metamaterial of the present disclosure, the holey arrangement array comprises a 3×3 array or a 5×5 array.

In yet a further preferred aspect, a metamaterial of the present disclosure further comprises one or more level or planar surfaces.

In another preferred aspect of a metamaterial of the present disclosure, the metamaterial undergoes pattern transformation under compression to allow vertical displacement of the metamaterial, equivalent to a dimension of the holey arrangement array, from a default position and when compression of the metamaterial is discontinued, the metamaterial undergoes another pattern transformation and returns to the default position.

In a further preferred aspect of a metamaterial of the present disclosure, the auxetic lattice structure comprises a material with a low Young's modulus (E) and high Poisson's ratio (v).

In another preferred aspect, the present disclosure comprises a metamaterial, comprising: a flex design comprising a concrete or cement material disposed in an auxetic structure with snap-through buckling behavior; and a cement, concrete or any other brittle materials disposed in the auxetic lattice structure.

In another preferred aspect of a metamaterial of the present disclosure, the auxetic structure has a plurality of rows and defines a holey arrangement array.

In yet another preferred aspect of a metamaterial of the present disclosure, the auxetic structure comprises a polymer or a thermoplastic polyurethane.

In a further preferred aspect of a metamaterial of the present disclosure, each row of the auxetic structure defines a channel or conduit in which the cement, concrete or any other brittle materials are disposed.

In another preferred aspect of a metamaterial of the present disclosure, each row defines one or more curved sections.

In an additional preferred aspect of a metamaterial of the present disclosure, the cement or concrete comprises a mixture of Type I/II Portland cement and water.

In yet another preferred aspect of a metamaterial of the present disclosure, the a maximum water to cement ratio of 0.45.

In another preferred aspect of a metamaterial of the present disclosure, the compressibility of the metamaterial is varied by varying the Young's Modulus and/or Poisson's Ratio of the auxetic lattice structure and/or the cement or concrete.

In yet another preferred aspect of a metamaterial of the present disclosure, the metamaterial does not exhibit transverse strain under compression.

In another preferred aspect of a metamaterial of the present disclosure, the holey arrangement array comprises a 3×3 array or a 5×5 array.

In yet a further preferred aspect, a metamaterial of the present disclosure further comprises one or more level or planar surfaces.

In another preferred aspect of a metamaterial of the present disclosure, the metamaterial undergoes pattern transformation under compression to allow vertical displacement of the metamaterial, equivalent to a dimension of the holey arrangement array, from a default position and when compression of the metamaterial is discontinued, the metamaterial undergoes another pattern transformation and returns to the default position.

In yet another preferred aspect of a metamaterial of the present disclosure, the auxetic structure comprises a material with a low Young's modulus (E) and high Poisson's ratio (v).

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 shows a preferred composite metamaterial concrete system with self-recovering snapping segments of the present disclosure.

FIG. 2 shows an example of a unit of material under compression exhibiting positive Poisson's ratio (top) and negative Poisson's ratio (bottom).

FIG. 3. shows preferred metamaterial concrete polymeric lattices of the present disclosure comprised of (a) 3×3 unit cells and (b) 5×5 unit cells.

FIG. 4. shows preferred fabricated metamaterial concrete polymeric lattices of the present disclosure comprised of (a) 3×3 unit cells, (b) 5×5 unit cells.

FIG. 5. shows the results of stiffness versus time for tests at Stage 1 compression for a preferred concrete metamaterial of the present disclosure at: (a) 4 mm vertical displacement, (b) 5 mm vertical displacement.

FIG. 6. shows P-δ curves illustrated for preferred concrete metamaterials of the present disclosure comprising: (a) a 3×3 unit cell concrete metamaterial 10A and (b) a 5×5 unit cell concrete metamaterial 10B.

FIG. 7. shows cyclic compression strain readings plotted against time for preferred concrete metamaterials of the present disclosure comprising: (a) a 3×3 unit cell concrete metamaterial 10A measured with a side gauge, (b) a 3×3 unit cell concrete metamaterial 10A measured with a center gauge and (c) a 5×5 unit cell concrete metamaterial 10B measured with a side gauge.

FIG. 8. shows ultimate compression strain readings plotted against time for preferred concrete metamaterials of the present disclosure comprising: (a) 3×3 unit cell concrete metamaterial 10A measured with a side gauge and (b) 3×3 unit cell concrete metamaterial 10A measured with a center gauge.

FIG. 9. shows FE simulation results comprising: (a) Mises stresses, (b) Transverse strains, (c) Longitudinal strains for a preferred concrete metamaterial of the present disclosure comprising a 3×3 unit cell concrete metamaterial.

FIG. 10. shows illustrations of damage progression through a cycle of compression for preferred concrete metamaterials of the present disclosure comprising: (a) a 3×3 unit cell concrete metamaterial 10A and (b) a 5×5 concrete metamaterial 10B.

FIG. 11. shows a preferred unit slab concept design for the 3×3 metamaterial polymer formwork of the present disclosure with potential applications of the proposed metamaterial concrete: (a) a high energy absorbing engineered materials arresting system, (b) metamaterial concrete base isolation system, (c) A shock absorbent bike lane pavement.

### DETAILED DESCRIPTION

### Principles of Metamaterial Concrete Systems

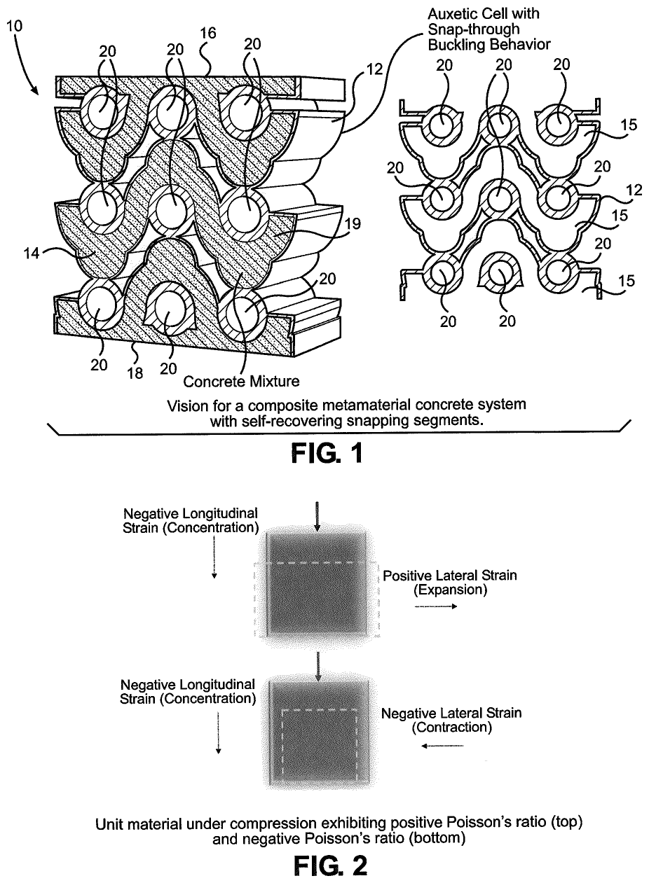

Classifying a metamaterial is not based on material composition. What really defines a metamaterial is the geometrical arrangement of the subunits, which can bestow unthinkable properties such as zero or negative Poisson's ratio, negative stiffness, negative compressibility, and vanishing shear modulus [9,10]. FIG. 1 shows a preferred composite metamaterial concrete system 10 of the present disclosure with tunable buckling, self-recovering, and energy absorption responses. The metamaterial concrete 10 of the present disclosure is naturally a mechanical metamaterial with zero Poisson's ratio because of its auxetic geometry. Mathematically speaking, Poisson's ratio is the negative ratio of lateral strain to longitudinal strain. FIG. 2 shows a schematic representation of the positive and negative Poisson's ratio. A specimen placed under uniform compression in the longitudinal direction normally shrinks longitudinally and expands laterally. Instead of expanding laterally, an auxetic metamaterial with negative Poisson's ratio is designed to shrink laterally under compression [9]. A preferred metamaterial concrete system 10 of the present disclosure with zero Poisson's ratio does not exhibit transverse strain under compression. Preferred concrete metamaterials of the present disclosure achieve this unique feature via introducing the so-called “Flex Design”, where conventional concrete materials 14 are cast into an auxetic mechanical metamaterial polymeric structure 12 with snap-through buckling behavior. This hybrid design approach could significantly increase the compressibility of the concrete materials. The compressibility of a rigid body can be defined in engineering terms as the inverse of the body's bulk modulus (K). K is also known as the modulus of volume expansion as it is inherent material resistance to volumetric change. Preferably, the compressibility of a metamaterial concrete 10 of the present disclosure can be fine tuned by interfacing materials with different Young's Moduli and Poisson's Ratio in unique geometries. The design follows principles of symmetry and contains two level surfaces 16, 18 for load bearing purposes.

The metamaterial concrete 10 of the present disclosure undergoes pattern transformation under compression to allow vertical displacement equivalent to the size of the unit cells. If the force is released, the metamaterial concrete 10 undergoes another pattern transformation and returns to the default position. This compressibility is further improved by the auxetic cells 12 connecting the holey arrangement that comprises an array of holes 20 preferably defined by a plurality of open cylinders 21. The metamaterial concrete 10 is afforded two degrees of freedom of compressibility where it can volumetrically contract under an applied load and completely recover when the load is released. The most suitable material for the design of the embedded auxetic polymeric structure 12 is preferably a material with a low Young's modulus (E) and high Poisson's ratio (v). In a preferred metamaterial concrete 10 of the present disclosure, the cement paste mixture provides the required strength and stiffness needed to complete the composite metamaterial 10. The remaining geometry of the metamaterial concrete 10 of the present disclosure interlinks the auxetic arrangement. Therefore, the concrete provides horizontal and vertical stability, and enhanced compressibility. Here, the embedded auxetic structure 12 also serves as concrete reinforcement and defines channels or conduits 22 for receiving the concrete 14. The difference in concrete failure modes is completely different when reinforcement is used. An increasingly popular type of concrete reinforcement is fiber reinforced polymer (FRP). FRPs are lighter and more corrosion resistant than steel rebar [11]. The fiber in FRP is typically made of carbon or glass, which is woven into a thin fabric and wrapped around the cylinders after the specimen cure. Exterior reinforcement still provides the increased tension capacity of steel rebar, but also increases the compression efficiency of concrete. The current limitation of the FRP concrete is the bonding between the reinforcement and the concrete. For instance, when steel reinforced concrete experiences large bending forces, the rebar deforms and forms a much stronger bond to the concrete. In the FRP applications, the bonding between the FRP and concrete is not strengthened by applied loading, rather it is the first component to fail in this system [11,12]. The preferred auxetic polymeric structures 12 of the present disclosure takes these shortcomings into consideration and provides a solution that would keep the concrete and polymer reinforcement structures 12 bonded in all possible loading conditions. The geometry of the preferred concrete metamaterials 10 of the present disclosure prevent lateral expansion similar to the FRP reinforcement but also allows for energy dissipation to ensure that neither the polymer structure 12 nor the concrete 14 incur any damage. Preferred concrete metamaterials 10 of the present disclosure possess a property better known as damping, seen in more and more in seismic applications to reduce vibration fatigue on any structure. Under uniaxial compression, the composite metamaterial concrete 10 of the present disclosure can be compressed significantly and completely recover in a matter of seconds. Even when flaws are present on a surface of the concrete 14, or a crack progresses in therein, the bonding between the polymer 12 and the concrete 14 is preferably strong enough to maintain the composite metamaterial 10 at full strength.

In order to validate the preferred concrete metamaterials 10 of the present disclosure, proof-of-concept porotypes were fabricated and tested them under cyclic loadings.

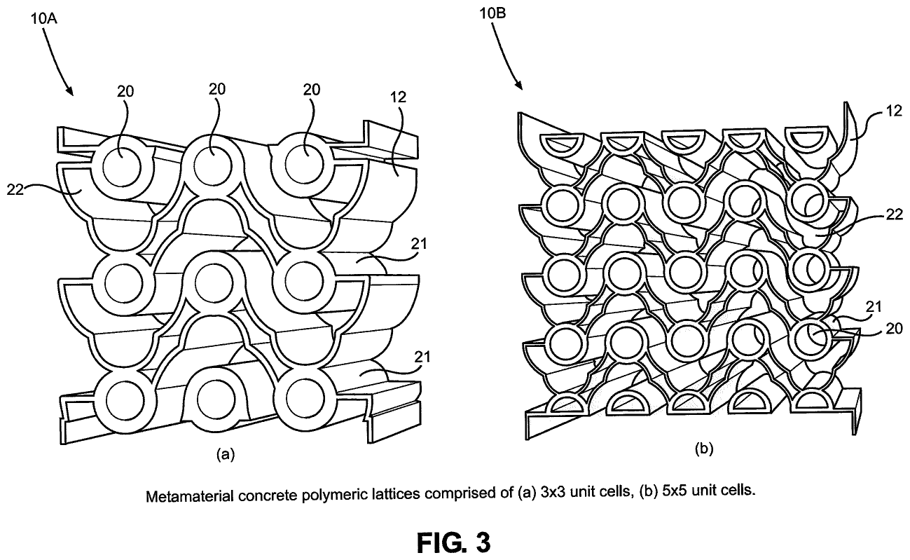

Most material innovations have a number of extended variables that can lead the designing engineer to the ideal strength and material behaviors. This principle would arguably apply to the preferred concrete metamaterials 10 of the present disclosure. The ideal ratio of polymer to concrete should be sought simultaneously. We created two potential metamaterial concrete designs with different amounts of polymer reinforcement to accomplish this task. The designs for polymeric lattices with self-recovering snapping segments are shown in FIG. 3. The first preferred concrete metamaterial design 10A with 3×3 unit cells has a lower ratio of polymer to concrete cement paste compared to the second preferred concrete metamaterial design 10B with a 5×5 unit cell design. Such ratio of polymer to concrete cement paste of the preferred concrete metamaterial designs 10A and 10B potentially affects the compressibility and magnitude of strain in the concrete cement paste thereof. Neither of these preferred concrete metamaterial designs 10A and 10B may qualify as the “ideal” material ratio as an ideal design is dependent on the realistic application of the material. For the testing purposes, we decided that cubic dimensions would provide empirical results regarding the longitudinal displacement and the subsequent recovery of the metamaterial when the compression is released. Therefore, the lattices 12 were scaled to 6 in×6 in×6 in as a testing standard for future iterations of this design. The auxetic lattices 12 were 3D printed using a Raise 3D Pro2 printer. PolyFlex™ filaments were used to print the samples. PolyFlex™ TPU95 is a thermoplastic polyurethane (TPU) based filament available from Polymaker LLC at www.polymaker.com. In addition to the PolyFlex auxetic lattices 12, a modular 6 inch cubic base was printed to stabilize the metamaterial designs during the pour phase.

The concrete portion 14 of the composite concrete metamaterial 10 is preferably cement paste, a basic mixture of Type I/II Portland cement and water. ACI 318-14 Table 19.3.2.1 specifies a maximum water to cement ratio of 0.45 or 45% for plain concrete [13]. This was considered a sufficient starting point for the concrete sections. The pours were executed carefully for each metamaterial design to avoid distorting the geometry of the PolyFlex polymer reinforcement structures 12, which would conversely affect the overall compressibility of the concrete metamaterial 10. Each section or row 15 was filled with the concrete 14 in increments of 2 inches and the layer was consolidated with a small metal rod or gentle vibrations to the mold walls using a rubber mallet. When the cement paste reached the top of the mold, the cover was gently cleaned to avoid any binding with the cement paste as the sample cured. The top was covered, and the sample set aside to dry for 24 hours. Once the samples were drying, the modular molds and covers were gently removed, and the samples submerged in water to cure. The samples were cured for 2 weeks, and once finished they were removed from the water and prepared for the testing phase.

Static testing performance of each design 10A, 10B was assessed via the Instron® 8874 Biaxial Servohydraulic Fatigue Testing System. There were two tests implemented to estimate the compressive properties of both metamaterial designs 10A, 10B. Both designs 10A, 10B were initially tested in cyclic compression, consisting of 10 cycles of compression and subsequent release at a rate of 0.05 Hz. These trials were repeated to increase the vertical displacement of the concrete metamaterial 10A, 10B from the default at rest state. Each trial in cyclic compression will be referred to as a stage in this present disclosure. The vertical displacement was deliberately kept small as to not exceed the space allocated by the auxetic cells 12. Following these tests, the samples were placed under ultimate compression. Ultimate compression featured a one-time vertical displacement exceeding the auxetic cell space to observe how the concrete metamaterials 10A, 10B would recover under extreme loading conditions. The compression rate was the same as cyclic compression and once the position was achieved, each concrete metamaterial 10A, 10B was held there for 10 seconds and released.

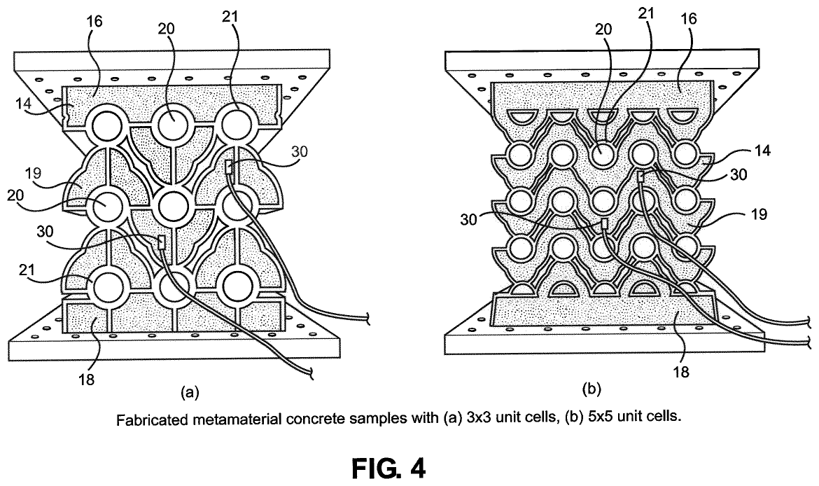

Another important parameter to analyze while the concrete metamaterials 10A, 10B are under compression is the strain in the cement paste layers 14. It is important to observe the magnitude and orientation of the strains in the cement layer 14 to analytically prove that each concrete metamaterial 10A, 10B only keeps the cement paste 14 engaged in compression. For this purpose, the middle cement layer 19 for each concrete metamaterial 10A, 10B was chosen as the focal point for strain analysis. The strain analysis was set to occur at the central cement paste layer 19 of each concrete metamaterial 10A, 10B. To observe the relative strains in the cement layer 14, a strain gauge 30 was placed at approximately 2 in (⅓ of the horizontal distance of the layer) and another at approximately 4 in (⅔ of the horizontal distance of the layer) (FIG. 4). Aside from comparing the compressibility of each concrete metamaterial 10A, 10B, a baseline comparison to concrete was also desired. To illustrate this comparison experimentally, the molds were reused to cast a plain cement paste cube to serve as the control variable in testing. The same water to cement ratio and cure times were implemented to ensure an accurate baseline comparison.

The 3×3 metamaterial concrete 10A was tested over two trials in three stages of cyclic compression. The first trial achieved vertical displacements of 5 mm, 8 mm, and 11 mm for Stages 1, 2, and 3, respectively. The second trial achieved vertical displacements of 4 mm, 9 mm, and 12 mm for Stages 1, 2, and 3, respectively. Table 1 shows the stages of cyclic compression for the 3×3 metamaterial concrete 10A.

TABLE 1
Cyclic compression stages for the
3 × 3 metamaterial concrete 10A.

| | Cross | | | | |
|---|---|---|---|---|---|
| | Sectional | Initial | Final | Initial | Final |
| 3 × 3 | Area | Height | Height | Volume | Volume |
| Metamaterial | (mm²) | (mm) | (mm) | (mm³) | (mm³) |
| Stage 1 - Trial 1 | 22500 | 150 | 145.99 | 3,375,000 | 3,284,775 |
| Stage 1 - Trial 2 | | | 144.99 | | 3,262,267 |
| Stage 2 - Trial 1 | | | 141.98 | | 3,194,596 |
| Stage 2 - Trial 2 | | | 141.99 | | 3,194,705 |
| Stage 3 - Trial 1 | | | 138.98 | | 3,127,120 |
| Stage 3 - Trial 2 | | | 137.98 | | 3,104,459 |

For the 5×5 metamaterial concrete 10B, the first trial only made it to one stage of 5 mm vertical displacement due to overconsolidation of cement paste at the bottom layer of the PolyFlex mold. The overconsolidation forced closure of the auxetic cells on one side of the PolyFlex mold preventing proper compression recovery. The second trial produced viable results achieving 2 mm, 4.5 mm, 7 mm, and 9.5 mm for Stages 1, 2, 3, and 4, respectively (Table 2).

TABLE 2
Cyclic compression stages for the
5 × 5 metamaterial concrete 10B.

| | Cross Sectional | Initial | Final | Initial | Final |
|---|---|---|---|---|---|
| 5 × 5 | Area | Height | Height | Volume | Volume |
| Metamaterial | (mm²) | (mm) | (mm) | (mm³) | (mm³) |
| Stage 1 | 22500 | 150 | 147.99 | 3,375,000 | 3,329,852 |
| Stage 2 | | | 145.49 | | 3,273,538 |
| Stage 3 | | | 142.99 | | 3,217,188 |
| Stage 4 | | | 140.48 | | 3,160,776 |

One potential source of error in the positioning that would introduce errors in following calculations is the recovery distance of each concrete metamaterial 10A, 10B was not maximized prior to each subsequent stage of compression. It was observed that the Instron would initiate the next cycle before each concrete metamaterial 10A, 10B had a chance to fully recover to the initial position. This error was eliminated in the above calculations by only considering the change in position after the beginning of the second cycle. With that in mind, the important properties such as bulk modulus, recovery rate, and stiffness may be slightly higher due to this adjustment. The Instron device also recorded the magnitude of the applied compression load over time. Unlike the position, the applied load took longer to stabilize over 10 cycles of compression. Typically, the load cycles attained consistency after the 5^{th} or 6^{th} cycle of compression. In attempting to stabilize, the Instron would not adequately release each concrete metamaterial 10A, 10B and compensated by applying a larger compressive force in the next cycle. This phenomenon was noted, and the unstable data eliminated when considering the maximum load applied to each concrete metamaterial 10A, 10B during each cyclic testing stage. Given a uniform cross-sectional area, a maximum change in pressure was calculated for each cyclic stage (Table 3).

TABLE 3
Maximum loading conditions observed at each stage
for each concrete metamaterial 10A, 10B.

| | | Maximum | Max Pressure |
|---|---|---|---|
| | Stage | Force (N) | (MPa) |
| 3 × 3 | Stage 1 - Trial 1 | 2798 | 0.124 |
| Metamaterial | Stage 1 - Trial 2 | 1088 | 0.053 |
| | Stage 2 - Trial 1 | 2934 | 0.130 |
| | Stage 2 - Trial 2 | 1160 | 0.060 |
| | Stage 3 - Trial 1 | 1392 | 0.068 |
| | Stage 3 - Trial 2 | 3205 | 0.142 |
| 5 × 5 | Stage 1 | 1091 | 0.048 |
| Metamaterial | Stage 2 | 3590 | 0.160 |
| | Stage 3 | 5190 | 0.231 |
| | Stage 4 | 5787 | 0.257 |

### Calculating the Bulk Modulus

K is a materials inherent resistance to volumetric change under an applied pressure. This can be represented by the equation

$$K = - V \frac{d P}{d V} ,$$

where V is the initial volume, dP is the differential change in pressure, and dV is the differential change in volume. Since the element under consideration is not on a differential scale, this equation can be modified to

$$K = - V \frac{Δ P}{Δ V} .$$

The volumetric changes in the specimen shown above was calculated from the achieved vertical displacement at each stage of cyclic compression. Coupling that with the maximum applied pressure to achieve the desired displacement, all of knowns are present to approximate the bulk modulus for each stage. Table 4 shows the averaged outcomes to make accumulative approximation of the bulk modulus of each concrete metamaterial 10A, 10B.

TABLE 4
Bulk moduli calculated at each stage
each concrete metamaterial 10A, 10B.

| 3 × 3 Metamaterial | K (MPa) | 5 × 5 Metamaterial | K (MPa) |
|---|---|---|---|
| Stage 1 - Trial 1 | 4.65 | Stage 1 | 3.62 |
| Stage 1 - Trial 2 | 1.57 | Stage 2 | 5.31 |
| Stage 2 - Trial 1 | 2.44 | Stage 3 | 4.93 |
| Stage 2 - Trial 2 | 1.13 | Stage 4 | 4.05 |
| Stage 3 - Trial 1 | 0.93 | Mean | 4.48 |
| Stage 3 - Trial 2 | 1.78 | — | — |
| Mean | 1.57 | Mean | 4.48 |

It was inferred that the 3×3 concrete metamaterial 10A would exhibit higher compressibility due to the larger space afforded by the auxetic cells. Conceptually speaking, these larger gaps of free space would permit larger compression and recovery without significant damage to the concrete layers. As indicated by the data, this thought process holds true as the mean bulk modulus of the 3×3 concrete metamaterial 10A is approximately 3 times less than the 5×5 each concrete metamaterial 10B. Based on this trend, it would be desirable to direct future work towards designing different arrangements to devise a way to fine tune bulk modulus. A definitive proportion cannot be established at this point, but a trend has at least been revealed on how to control this material property in design. Overall, each of the two concrete metamaterials 10A, 10B exhibited compressibility far beyond conventional concrete. Particularly, the mean values of both concrete metamaterials 10A, 10B fell in the vicinity of silicone rubber, which possesses an approximate bulk modulus of 2 GPa. Both concrete metamaterials 10A, 10B exhibit compressibility over a factor of 1000 times that of silicone rubber. Conventionally, the properties and behaviors of both materials are exactly the opposite. Concrete exhibits extremely high relative stiffness (high modulus, high density) whereas rubber has close to no relative stiffness (low modulus, low density). In fact, the present disclosure below describes how rubber is commonly used for damping at the base of concrete structures as relative stiffness may work for bearing high loads, but consequentially means the material has close to no strain energy. Yet the concrete metamaterials 10A, 10B have effectively reversed the material properties of concrete and endowed rubber like behavior. The material itself has not changed, but the unique reinforcement design of the concrete metamaterials 10A, 10B creates an overall composite with unique capabilities.

### Calculating the Stiffness

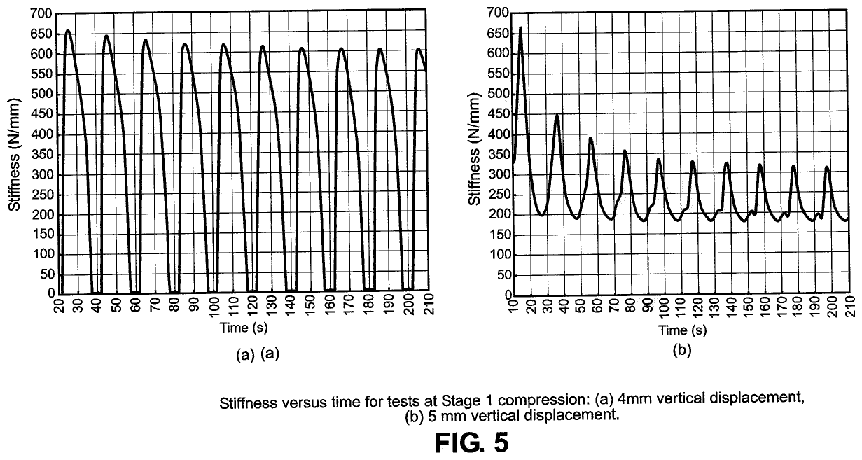

A concern that would be immediately cited with compressive concrete is a massive sacrifice in stiffness to inversely increase the compressibility of the material. Following up from the discussion of the previous paragraph, achieving high compressibility involves the loss of relative stiffness. Aside from the equation cited in the previous paragraph the bulk modulus can also expressed as

$$K = \frac{E}{3 ( 1 - 2 v )} ,$$

where E and v are the Elastic Modulus and Poisson's Ratio of the material, respectively [14]. Based on this equation, an ultra-compressive material will either have a low modulus or exhibit large lateral deformations in compression (large Poisson's Ratio). As stiffness is the material resistance to deformation, it seems inherently impossible for a material to be both stiff and compressible. As set forth below, the concrete metamaterials 10A, 10B of the present disclosure still maintains high stiffness that accompanies the low bulk modulus calculated above. The fundamental way to assess the stiffness of each concrete metamaterial 10A, 10B under compression is to consider the vertical deflection (δ) under the applied load (P). Given the magnitude of the compressive load and vertical displacement by the Instron, the stiffness of each concrete metamaterial 10A, 10B material could be calculated for both cyclic and ultimate compression tests. The stiffness values were plotted against time to get a visual understanding of how the stiffness of each concrete metamaterial 10A, 10B changed for each cycle and stage of compression. For cyclic compression, the stiffness values were relatively unstable. FIG. 5 visualizes the wide fluctuation of stiffness between different stages cyclic compression. The stiffness decreases after the first cycle and it takes several cycles for the peak stiffness values to stabilize. This error is directly correlated to the instability in the loading applied by the Instron explained above.

One key observation from these cyclic stiffness charts and by observing the behaviors of the concrete metamaterials 10A, 10B during testing is the startling similarity to a stiff spring. This conceptual understanding initiated the idea for ultimate compression in the second trial of testing. Doing so provided clearer indication of the deformation resistance of each concrete metamaterial 10A, 10B. Following a similar procedure to cyclic compression, both concrete metamaterials 10A, 10B were tested in different ultimate compression stages applying larger vertical deformation for each successive stage. As shown in Table 5, the 3×3 concrete metamaterial 10A achieved 15 mm, 17.5 mm, and 20 mm of compression for Stages 1, 2, and 3, respectively. The 5× concrete metamaterial 10B achieved 12.5 mm, 15 mm, 17.5 mm, and 20 mm of compression for Stages 1, 2, 3, and 4, respectively (Table 5).

TABLE 5
Expanded ultimate compression stages
for concrete metamaterials 10A, 10B.

| | | Initial | Final | Initial | Final |
|---|---|---|---|---|---|
| | | Height | Height | Volume | Volume |
| | Stage | (mm) | (mm) | (mm³) | (mm³) |
| 3 × 3 | Stage 1 | 150 | 134.98 | 3,375,000 | 3,037,051 |
| Metamaterial | Stage 2 | | 132.48 | | 2,980,762 |
| | Stage 3 | | 129.98 | | 2,924,465 |
| 5 × 5 | Stage 1 | 150 | 137.48 | 3,375,000 | 3,093,337 |
| Metamaterial | Stage 2 | | 134.98 | | 3,037,050 |
| | Stage 3 | | 132.48 | | 2,980,730 |
| | Stage 4 | | 129.98 | | 2,924,451 |

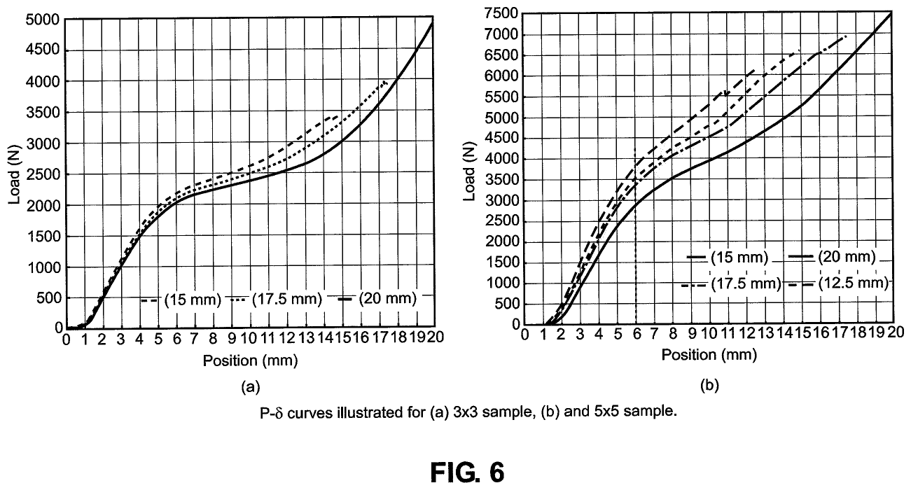

The axial load-deformation curves were obtained for the loading phase of each concrete metamaterial 10A, 10B. This is defined by the time interval where the compression loading is applied to the moment when the load is released. FIG. 6 shows the obtained P-δ curves.

Hooke's Law stipulates the stiffness of a material marks the transition from elastic to deformed behavior. During elastic behavior, the deformation curve is linear indicating the rise in vertical displacement of the concrete metamaterial 10A, 10B is directly proportional to the rise in compression applied by the Instron device. Once elastic behavior is lost, there is a brief “yield” phase where the auxetic cells 12 of the PolyFlex completely closed and the concrete layers 14 begin to fully bear the applied compressive load. This essentially starts a new deformation curve for the concrete constituency. As the stiffness of the concrete metamaterial 10A, 10B is desired, this secondary curve will not be evaluated any further. Returning to the elastic zone of the deformation curves, the transition points are delineated at 5 mm, and 6 mm of vertical displacement for the 3×3 concrete metamaterial 10A and 5×5 concrete metamaterial 10B, respectively. Given the load magnitude for each stage of ultimate compression at this transitional position, the stiffness in N/mm was computed. The average of these computations was taken to provide a cumulative estimate of the stiffness for both concrete metamaterials 10A, 10B. The results are shown in Table 6.

TABLE 6
Computed stiffness values for the ultimate compression
testing of each concrete metamaterial 10A, 10B.

| | | Load at | |
|---|---|---|---|
| | | Transition | Stiffness |
| | Stage | (N) | (N/mm) |
| 3 × 3 | Stage 1 | 1952 | 390 |
| Metamaterial | Stage 2 | 1868 | 374 |
| | Stage 3 | 1803 | 360 |
| | Mean | 1874 | 382 |
| 5 × 5 | Stage 1 | 3794 | 632 |
| Metamaterial | Stage 2 | 3507 | 584 |
| | Stage 3 | 3373 | 561 |
| | Stage 4 | 2890 | 481 |
| | Mean | 3391 | 565 |

### Strain Analysis

For the duration of both trials of cyclic testing, the strains were recorded via the two gauges 30 placed at the central concrete layer 19 of each of the concrete metamaterials 10A, 10B. It was of interest to understand the strain in the concrete part 14, 19 of each concrete metamaterial 10A, 10B to verify the load reduction provided by the PolyFlex reinforcement 12. Also given the intricate geometry of the concrete layers 14, 19, it was desired to pinpoint the areas of geometry bound to undergo the largest stress. Mapping out the strain distribution will contribute at future design modifications aimed at curtailing unusually high stresses brought upon by the original design. The middle layer 19 of each concrete metamaterial 10A, 10B was chosen as that layer experienced full vertical displacement and was equidistant from the interfacing surfaces 16, 18 between each concrete metamaterial 10A, 10B and the Instron device. The maximum and minimum strains were obtained, and the difference taken to assess the change in strain between compression and release. The results for the 3×3 concrete metamaterial 10A and 5×5 concrete metamaterial 10B are shown in Tables 7 and 8, respectively. The strain sensor 30 located at the center of concrete layer 19 of the 5×5 concrete metamaterial 10B failed to produce viable readings leaving only the strain measurements at the side of layer 19.

TABLE 7
Measured strain values for the cyclic compression
testing of the 3 × 3 concrete metamaterial 10A.

| 3 × 3 Metamaterial | Central Strain (με/ε) | | | Side Strain (με/ε) | | |
|---|---|---|---|---|---|---|
| Strains | Maximum | Minimum | Difference | Maximum | Minimum | Difference |
| Stage 1 - Trial 1 | −4.63E−06 | −2.49E−05 | 2.02E−05 | −1.01E−06 | −3.56E−05 | 3.46E−05 |
| Stage 1 - Trial 2 | 4.67E−06 | −1.46E−05 | 1.93E−05 | 1.31E−05 | −3.02E−05 | 4.34E−05 |
| Stage 2 - Trial 1 | 6.05E−06 | −2.88E−05 | 3.49E−05 | 1.19E−06 | −4.52E−05 | 4.64E−05 |
| Stage 2 - Trial 2 | −7.24E−06 | −2.69E−05 | 1.97E−05 | 7.13E−06 | −3.82E−05 | 4.54E−05 |
| Stage 3 - Trial 1 | −1.38E−05 | −3.14E−05 | 1.76E−05 | 3.54E−06 | −4.12E−05 | 4.48E−05 |
| Stage 3 - Trial 2 | 4.08E−06 | −2.11E−05 | 2.52E−05 | 6.05E−06 | −4.40E−05 | 5.01E−05 |
| Mean | −2.99E−06 | −2.46E−05 | 2.28E−05 | 5.00E−06 | −3.91E−05 | 4.41E−05 |

TABLE 8
Measured strain values for the cyclic compression
testing of the 5 × 5 concrete metamaterial 10B.

| | |
|---|---|
| 5 × 5 Metamaterial | Side Strain (με/ε) |

| Strains | Maximum | Minimum | Difference |
|---|---|---|---|
| Stage 1 | −7.30E−06 | −2.02E−05 | 1.29E−05 |
| Stage 2 | −9.65E−06 | −2.76E−05 | 1.79E−05 |
| Stage 3 | −1.39E−05 | −3.00E−05 | 1.61E−05 |
| Stage 4 | −2.05E−05 | −3.84E−05 | 1.79E−05 |
| Mean | −1.28E−05 | −2.90E−05 | 1.62E−05 |

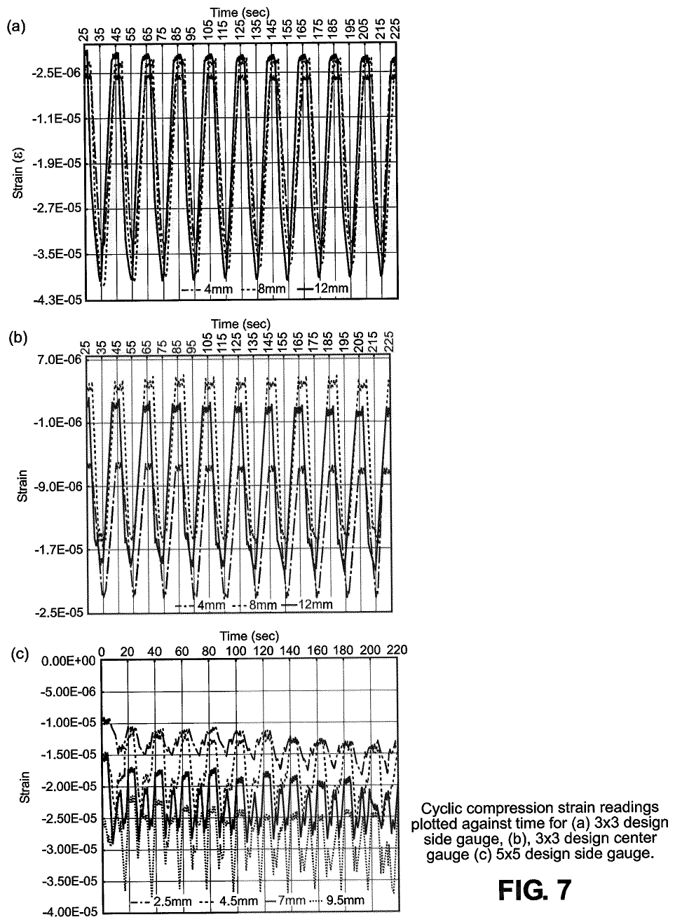

In addition to compiling the extreme strains in the data, the readings were plotted against time to assess if the readings aligned with the mechanics of cyclic compression (FIG. 7). The measurements showed the expected variation inherent to cyclic compression.

The strains at the center layer 19 for the 3×3 concrete metamaterial 10A showed the cleanest behavior where the peaks were centered around approximately −17.5με and uniformly increased between each successive stage. Note that there was a much larger increase in strain between Stages 1 and 2 compared to Stages 2 and 3 at the center of the layer 19. This indicates that the auxetic cells 12 have essentially closed and the concrete 14 is bearing the entirety of the load. The minimal change in strain is a testament to concrete strength in compression. Observing the changes on the side strain graph, the sensor readings were centered around −15με for the Stage 1 of compression, but suddenly jumps to −5με at Stage 2 before falling slightly to −7.5με at Stage 3. As the side strain gauge was located at the end of a curved portion of the layer this behavior is an effect of concrete arranged in a complicated geometry. At the height of compression for each stage, the layer 19 would experience a positive moment and the ends of the layer 19 would slightly rotate. This explains the sudden transition from negative to positive strains as the compression distance increased. Then from Stages 2 to 3, the decrease in strain may be due to further rotation of the layer shifting the stresses farther to the sides of the layer. This goes hand in hand with the minimal increase in strain at the center of the layer 19 as well.

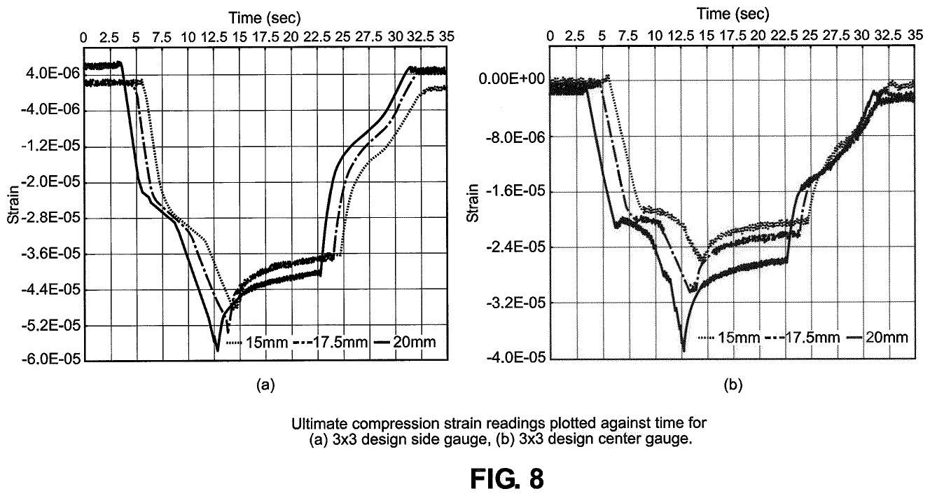

The strain measurements at the side of layer 19 of the 5×5 concrete metamaterial 10B showed an opposite trend to the 3×3 concrete metamaterial 10A, which saw greater negative strains corresponding to increased compression distance. This is simply because the 5×5 concrete metamaterial 10B was compressed in inverse manner to the 3×3 concrete metamaterial 10A, which switched the sign on the strain measurements. The strain measurements at Stages 1 and two were aligned at the peaks, yet the strain cycles at Stage 2 were roughly twice the size. The cycles remained the same size from Stages 2 through 4 but shifted downward 7.5με between Stage 2 and 3, and 5με between Stages 3 and 4. Given that the change is vertical displacement is the same between these stages (2.5 mm) the slight decrease of the change in strain can be attributed to what was observed for the 3×3 concrete metamaterial 10A. The compactness and higher deformation resistance of the 5×5 concrete metamaterial 10B did not make the flow of forces as apparent, but as the vertical compression distance is increased the load seems to shift towards the outside of the specimen thereby decreasing the strain values exhibited at the center of the layer 19. FIG. 8 shows the strain readings obtained for the multiple stages of ultimate compression testing. Significant damage was incurred by the concrete layers 14 during this phase of testing since the displacement was past the spatial limit of the PolyFlex reinforcement 12.

For the 3×3 concrete metamaterial 10A, the strain values peaked at the side and center of the layer 19 at approximately 12.5 seconds. This did not correspond to when the concrete metamaterial 10A was released during ultimate compression testing at 20 seconds. This is most likely because the loading did not increase after 10 seconds, resulting in a sharp peak and decrease in the strain values. Between stages the strain magnitude did not vary significantly and exhibited an increasing negative trend with the peak occurring sooner for each subsequent stage. The position of the strain gauges 30 was highly coordinated for this phase of testing with the strain readings off center reporting peak values roughly 2με lower than the measurements at the center of the layer 19 for each stage. From cyclic compression, it was observed the sides experienced a positive moment in the latter stages of testing, but this did not occur during ultimate compression. After the auxetic cells 12 of the PolyFlex closed, the side rotation stopped, and the concrete layers 14 were fixated in pure compression. Therefore, the strain measurements at this phase of testing showed higher magnitudes and overall consistency. The strain measurements for the 5×5 concrete metamaterial 10B were much more erroneous and did not shown any viable or consistent trends compared to the 3×3 concrete metamaterial 10A. Since the measurements at the center of the layer 19 were discarded altogether for similar reasons, the strain readings for this phase of testing are not shown.

### Finite Element Modelling

To further analyze the comprehensive geometry, the designs of each concrete metamaterial 10A, 10B was uploaded to Abaqus CAE to generate a finite element model (FEM) that could simulate all the actual testing performed on the metamaterials. The complexity of both concrete metamaterials 10A, 10B generated a robust FEM that would have taken massive computational power to achieve convergence. Therefore, the cross-sectional depth was removed and a 2D version of each concrete metamaterial 10A, 10B was used to simplify the FEM. The material properties of cement paste 14 and PolyFlex structure 12 were inserted and applied accordingly to each component of the FEM (Table 9).

TABLE 9
Material properties used for FE analysis.

| | Density | Youngs | Poisson's |
|---|---|---|---|
| Material | (kg/m3) | Modulus (Pa) | Ratio |
| PolyFlex (21.5° C.)¹⁵ | 1205 | 9,400,000 | N/A |
| Cement Paste¹⁶ | 1600 | 450,000,000 | 0.28 |

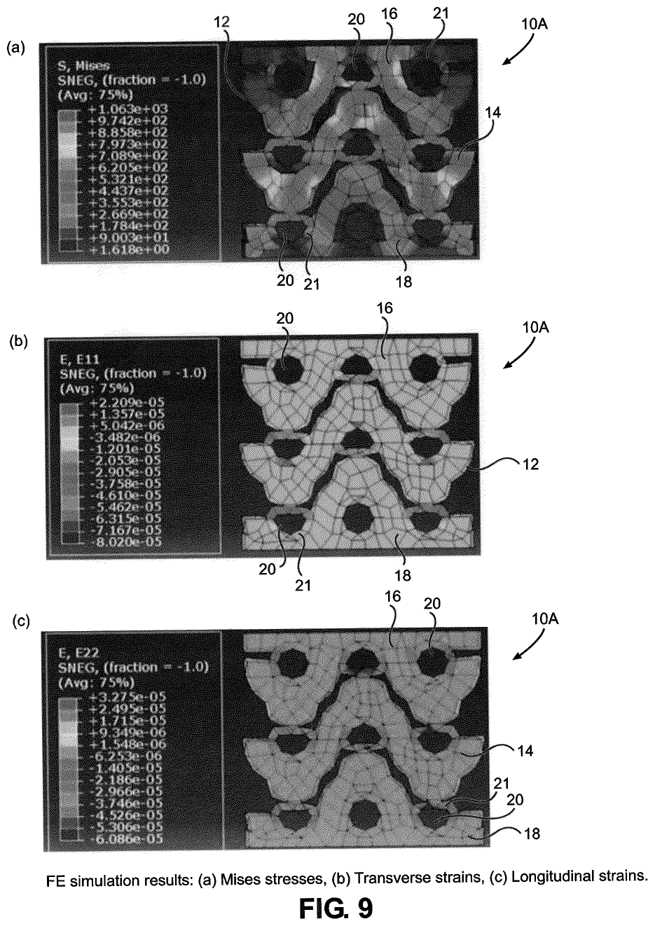

To begin, three steps were created as a placeholder for each stage of cyclic compression. Boundary conditions were applied to fix all degrees of freedom on the bottom surface and apply a vertical displacement equivalent to the maximum for each stage. The 5×5 concrete metamaterial 10B possessed more intricacies than the 3×3 concrete metamaterial 10A and required a much finer mesh to adequately encapsulate the geometry. Once a compression stage was simulated, a stress distribution was computed by Abaqus for the deformed state. Certain elements were able to be selected for the strain outputs, and the elements that coincided with the locations of the strain gauges during testing were chosen. The FE simulation results are shown in FIG. 9.

### Damage Resistance

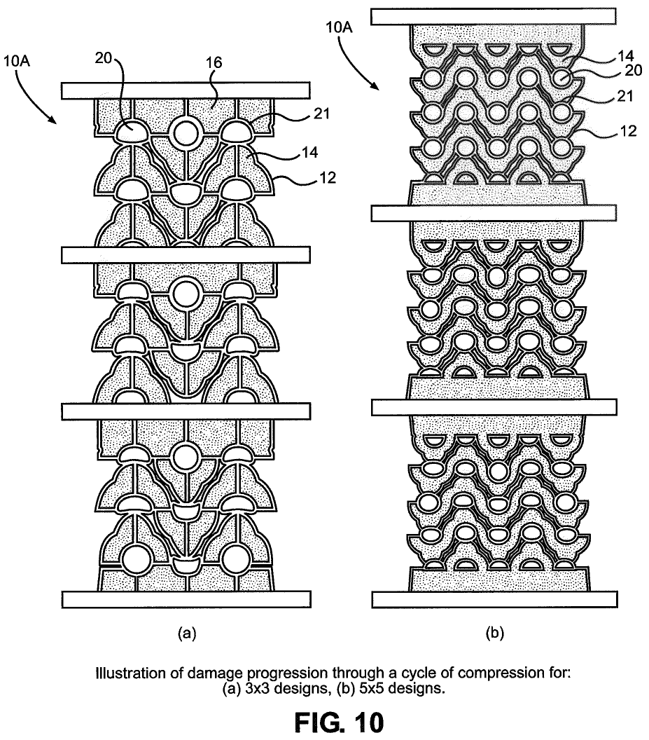

During both phases of testing, several cracks were observed in the concrete layers 14. Beginning in cyclic compression, these cracks achieved full vertical progression and parts of the cement paste layer were separated. FIG. 10 shows the damage progression through a cycle of compression. Despite damage in multiple layers, the material functionality and behaviors were not affected whatsoever. The bonding between the cement paste 14 and the polymer structure 12 was strong enough to maintain the stiffness and stability of each concrete metamaterial 10A, 10B. This further accentuates the potential high-level damping capabilities of the concrete metamaterials 10A, 10B. Here, the present disclosure presents a proof-of-concept compressible concrete metamaterials 10A, 10B using a simple cement mixture that has not yet been optimized for damage resistance. There are certainly multiple solutions to improve the cement/concrete mixture properties (e.g. adding fibers) for a better damage resistance.

### Future Work and Applications

The present disclosure has shown how preferred concrete metamaterials 10A, 10B can provide model extreme compressibility. Furthermore, any fault that occurs in the cement paste layers 14 do not impact the overall functionality of the concrete metamaterials 10A, 10B. As such, the concrete metamaterials 10A, 10B could very well be used in applications for which concrete has not previously been considered and bolster concrete performance in applications for which it is already considered efficient.

### Redefining the Concrete Beam

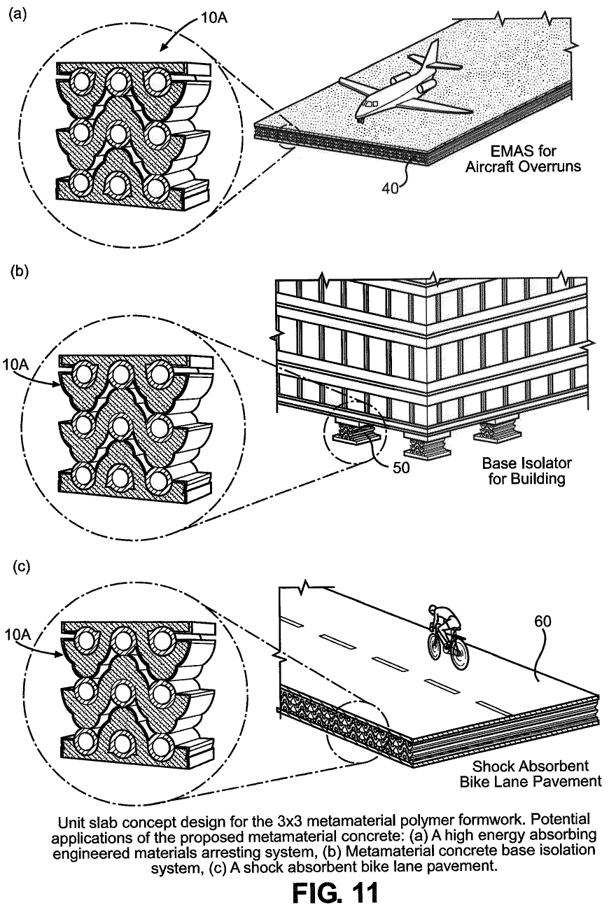

A cubic model of the concrete metamaterials 10A, 10B was chosen to obtain base material properties for the innovative material geometry and composite constituency of the present disclosure. By no means is this the final construction form for this concept. FIG. 11 illustrates larger specimen that better illustrates the future design goals for the composite concrete metamaterials of the present disclosure. This could be considered the very first concrete “beam-column” as it will have the ability to exhibit high resistance to compression and lateral forces. In concrete construction, concrete columns have the tendency to be overdesigned due to fear of unpredictable loads, which expose the weaknesses of concrete in tension and fatigue. As previously stated, the polymer reinforcement acts as a surface protect to prevent initial flaws on the concrete surface, preventing seepage and subsequent freeze-thaw effects in areas subject to seasonal changes. Also, the polymer reinforcement 12 was observed to have bonded so well with the cement paste 14, that full crack progression did not induce any observable loss in stiffness. The very weaknesses that engineers choose to overdesign concrete buildings for are eliminated through the innovations incorporated into the concrete metamaterials of the present disclosure, including concrete metamaterials 10A, 10B. The concrete metamaterials of the present disclosure may also supersede steel reinforcement of concrete in the long term as the polymer or PolyFlex structure 12 is an inert material and will not corrode or degrade over the serviceable lifetime of the structure. Design costs can be considerably decreased considering the all-around efficiency of the concrete metamaterials of the present disclosure.

FIG. 11. shows a preferred unit slab concept design for the 3×3 metamaterial polymer formwork 10A of the present disclosure with potential applications of the proposed metamaterial concrete of: (a) a high energy absorbing engineered materials arresting system 40, (b) metamaterial concrete base isolation system 50, (c) A shock absorbent bike lane pavement 60.

### Damping Capabilities

There is a stunning multitude of technologies to combat seismic forces on rigid structures, yet an ideal solution has yet to be found that combines low cost with high seismic resilience. The most popular solution is damping applications, to dissipate the energy of ground movement during an earthquake. Technically speaking these dampers are called base isolation systems, which serve to decouple a super structure from the ground and greatly reduce the effect of seismic loads [15]. These are found to greatly reduce building acceleration and inter-story drift of the superstructure. Elastomers are sought for this application as they exhibit high damping properties and can undergo nonlinear deformations while maintaining elastic behavior. As the relative stiffness of elastomers are so low, they are layered with thin metal plates as to maintain high damping characteristics under the sheer weight of the super structure. The primary setback of this method is the difficulty achieving the proper vibration frequency equivalent to that of a seismic event. Fundamentally speaking, a multi-story concrete structure requires damping for multiple degrees of freedom. Leaving a large unbraced length in a concrete girder or columns guarantees fatigue no matter how much you reduce vibrations at the base of the super structure. The concrete metamaterials of the present disclosure as described above can be both retrofitted to any concrete column size in a superstructure or precast and delivered in different concrete forms, notably columns or girders. The compressibility and stiffness of the concrete metamaterials of the present disclosure can be tuned based on the number of auxetic cells 12 included in the design. With further research and testing, this design can be matched to any known building frequency. Endowing concrete girders with damping capabilities will further improve the structural resistance of concrete to ground acceleration and inter-story drift. Rather than merely focusing on the interface between the superstructure and the subgrade, the concrete metamaterials of the present disclosure will enable a holistic approach to damping in concrete structures. Additionally, the concrete metamaterials of the present disclosure may also pose as an ideal solution for other types of structures beyond concrete. The first common concrete-only structures that struggle in terms of design longevity are parking garages. Concrete is the choice material as the dominating load to consider in the design of parking garages is compression. Though concrete is the correct choice for this application, there are other design variables in a parking garage that also work against conventional concrete. The first major issue is a phenomenon known as spalling. As previously mentioned, the brittleness of concrete tends to produce a lot of surface flaws, and it is bad news when moisture penetrates these surface flaws. The water that enters the surface can cause the flaw to progress deeper into the slab and increase the surface area of the flaw, allowing even more moisture to penetrate the concrete. It is a vicious cycle that can cost a lot in repairs as it may happen frequently in parking garages in areas of high moisture or precipitation.

Another factor to consider is vibration, which can be severe in peak traffic hours. To reiterate, the brittle nature of concrete means that the ability of this material to dissipate energy is close to nothing. That means the concrete columns in parking garages must be large as to not produce a lot of flaws in response to heavy vibration. The concrete metamaterials of the present disclosure are the perfect solution for columns or slabs in parking garages due to the polymer cover and extreme compressibility. The advantages of the polymer reinforcement 12 of the concrete metamaterials 10A, 10B were mentioned in the previous section, so consider how the compressibility completely changes how an engineer would approach this design. The design geometry endows the concrete metamaterials 10A, 10B of the present disclosure with the ability to dissipate vibration energy without producing any surface flaws in the concrete and it is now known that the concrete metamaterials 10A, 10B will still function at a high level with the presence of surface flaws. When considering the issues with concrete parking garages, the concrete metamaterials 10A, 10B could pose as a viable alternative for sidewalks, outdoor stairways, and Portland cement concrete (PCC) pavements. With these applications in particular, the advantage of using the concrete metamaterials 10A, 10B of the present disclosure is that the design does not require coarse aggregates in the concrete mixture. With some added strength, the concrete metamaterials 10A, 10B of the present disclosure would be useful for constructing sidewalks and roadways capable of energy dissipation from the passing of cars or human foot traffic. The responsivity of the concrete metamaterials of the present disclosure to compressive force may ensure a much longer serviceable lifetime for the sidewalk and/or roadway compared to what is used presently, further saving construction costs in the form of road repairs.

### CONCLUSION

The present disclosure is directed to design a new generation of concrete metamaterials with extreme compressibility and mechanical tunability. The concrete metamaterials of the present disclosure incorporate the fusion of snapping metamaterials and concrete design concepts. Integrating the concrete mixture 14 with auxetic polymer structures 12 with snap-through buckling behavior resulted in the concrete metamaterials 10A, 10B of the present disclosure having new functionalities. The developed proof-of-concept concrete metamaterials 10A, 10B were experimentally tested to verify the efficient of the proposed concept. The results were in a reasonable agreement with the numerical simulations. The abilities of the concrete metamaterials 10A, 10B could potentially revolutionize concrete construction as it supplements the inherent weaknesses of concrete in fatigue applications. The overall design of the concrete metamaterials 10A, 10B instead should be recognized as a concrete reinforced polymer as the polymeric auxetic metamaterial structure is what truly incorporates the compressible property into concrete. The composite constituency of the concrete metamaterials 10A, 10B showed levels of compressibility greater than cork, while maintaining a high level of stiffness. The compressibility of concrete metamaterials of the present disclosure provides for a ductile concrete, with a significantly higher flexural capacity and ability to absorb vibration without incurring any flaws. Preferably, more focus will be place on mechanical tunability of the concrete metamaterials of the present disclosure via parameters such as the number of auxetic cells, the polymer material and the composition of the concrete mixture. Additionally, future work preferably will focus on different empirical forms of the concrete metamaterials of the present disclosure, such as beams and slabs, which are likely to be the most widely used application for the concrete metamaterials of the present disclosure.

### REFERENCES

Y. Fu, X. Wang, L. Wang, Y. Li. Hindawi Advances in Materials Science and Engineering Volume 2020, Article ID 6153602, 25 pages.
[2] Wang, L., Jiang, H., Li, Z. et al. Mechanical behaviors of 3D printed lightweight concrete structure with hollow section. Archiv. Civ. Mech. Eng 20, 16 (2020).
[3] Brian Salazar, Parham Aghdasi, Ian D. Williams, Claudia P. Ostertag, Hayden K. Taylor, Polymer lattice-reinforcement for enhancing ductility of concrete, Materials & Design, Volume 196, 2020, 109184, ISSN 0264-1275,
[4] Lijing Kang, Wei Fan, Bin Liu, Yanzhi Liu, Numerically efficient analysis of concrete-filled steel tubular columns under lateral impact loading, Journal of Constructional Steel Research, Volume 179, 2021, 106564, ISSN 0143-974X,
[5] Zhijie Huang, Wensu Chen, Hong Hao, Zuyu Chen, Thong M. Pham, Tung T. Tran, Mohamed Elchalakani, Shear behaviour of ambient cured geopolymer concrete beams reinforced with BFRP bars under static and impact loads, Engineering Structures, Volume 231, 2021, 111730, ISSN 0141-0296,
[6] Jiao P., Alavi A. H., “Artificial intelligence-enabled smart mechanical metamaterials: advent and future trends”, International Materials Reviews, 1-29, 2020.
[7] Zadpoor A. A., Mechanical metamaterials. Mater. Horiz. 3, 371-381 (2016).
[8] Barri K., Zhang Q., Jiao P., Chen J., Wang ZL., Alavi A. H., “Multifunctional meta-tribomaterial nanogenerators for energy harvesting and active sensing”, Nano Energy, Article 106074, 2021.
[9] Xianglong Yu, Ji Zhou, Haiyi Liang, Zhengyi Jiang, Lingling Wu, Mechanical metamaterials associated with stiffness, rigidity and compressibility: A brief review, Progress in Materials Science, Volume 94, 2018, Pages 114-173, ISSN 0079-6425.
[10] Hang Yang, Li Ma, Multi-stable mechanical metamaterials with shape-reconFigureuration and zero Poisson's ratio, Materials & Design, Volume 152, 2018, Pages 181-190, ISSN 0264-1275, https://doi.org/10.1016/j.matdes.2018.04.064.
[11] Huang Gu, Zuo Zhong e, Compressive behaviours and failure modes of concrete cylinders reinforced by glass fabric, Materials & Design, Volume 27, Issue 7, 2006, Pages 601-604, ISSN 0261-3069.
[12] Chen, E., Berrocal, C. G., Lofgren, I. et al. Correlation between concrete cracks and corrosion characteristics of steel reinforcement in pre-cracked plain and fibre-reinforced concrete beams. Mater Struct 53, 33 (2020).
[13] ACI 318, Building Code Requirements for Structural Concrete (ACI 318-05) and Commentary (ACI 318R-05), ACI Committee 318, American Concrete Institute, Farmington Hills, MI, 2005
[14] Courtney, Thomas H. Mechanical Behavior of Materials. McGraw Hill Education (India), 2013.
[15] SteenhuisC., M. “Resistance and Stiffness of Concrete in Compression and Base Plate in Bending.” (2005).

All patents, patent applications, provisional applications, and publications referred to or cited herein are incorporated by reference in their entirety for all purposes.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A metamaterial, comprising:
an auxetic lattice structure with snap-through buckling behavior comprising a plurality of rows; wherein the lattice defines a holey arrangement array; and
cement, concrete or any other brittle materials disposed in the auxetic lattice structure.

2. The metamaterial of claim 1, wherein the auxetic lattice structure comprises a polymer.

3. The metamaterial of claim 1, wherein the auxetic lattice structure comprises a thermoplastic polyurethane.

4. The metamaterial of claim 1, wherein each row of the auxetic lattice structure defines a channel or conduit in which the cement, concrete or any other brittle materials are disposed.

5. The metamaterial of claim 4, wherein each channel or conduit has an open side or end for receiving the cement, concrete or any other brittle materials.

6. The metamaterial of claim 5, wherein each row defines one or more curved sections.

7. The metamaterial of claim 5, wherein each row defines a plurality of curved sections.

8. The metamaterial of claim 1, wherein the cement or concrete comprises a mixture of Type I/II Portland cement and water.

9. The metamaterial of claim 8, wherein a maximum water to cement ratio of 0.45.

10. The metamaterial of claim 1, wherein the compressibility of the metamaterial is varied by varying the Young's Modulus and/or Poisson's Ratio of the auxetic lattice structure and/or the cement or concrete.

11. The metamaterial of claim 1, wherein the metamaterial does not exhibit transverse strain under compression.

12. The concrete metamaterial of claim 1, wherein the holey arrangement array comprises a 3×3 array or a 5×5 array.

13. The concrete metamaterial of claim 1, further comprising one or more level or planar surfaces.

14. The metamaterial of claim 1, wherein the metamaterial undergoes pattern transformation under compression to allow vertical displacement of the metamaterial, equivalent to a dimension of the holey arrangement array, from a default position and when compression of the metamaterial is discontinued, the metamaterial undergoes another pattern transformation and returns to the default position.

15. The metamaterial of claim 1, wherein the auxetic lattice structure comprises a material with a low Young's modulus (E) and high Poisson's ratio (v).

16. A metamaterial, comprising:
a flex design comprising a concrete or cement material disposed in an auxetic structure with snap-through buckling behavior; and
a cement, concrete or any other brittle materials disposed in the auxetic lattice structure.

17. The metamaterial of claim 16, wherein the auxetic structure has a plurality of rows and defines a holey arrangement array.

18. The metamaterial of claim 16, wherein the auxetic structure comprises a polymer or a thermoplastic polyurethane.

19. The metamaterial of claim 17, wherein each row of the auxetic structure defines a channel or conduit in which the cement, concrete or any other brittle materials are disposed.

20. The metamaterial of claim 17, wherein each row defines one or more curved sections.

21. The metamaterial of claim 16, wherein the cement or concrete comprises a mixture of Type I/II Portland cement and water.

22. The metamaterial of claim 21, wherein a maximum water to cement ratio of 0.45.

23. The metamaterial of claim 16, wherein the compressibility of the metamaterial is varied by varying the Young's Modulus and/or Poisson's Ratio of the auxetic lattice structure and/or the cement or concrete.

24. The metamaterial of claim 16, wherein the metamaterial does not exhibit transverse strain under compression.

25. The metamaterial of claim 17, wherein the holey arrangement array comprises a 3×3 array or a 5×5 array.

26. The metamaterial of claim 16, further comprising one or more level or planar surfaces.

27. The metamaterial of claim 17, wherein the metamaterial undergoes pattern transformation under compression to allow vertical displacement of the metamaterial, equivalent to a dimension of the holey arrangement array, from a default position and when compression of the metamaterial is discontinued, the metamaterial undergoes another pattern transformation and returns to the default position.

28. The metamaterial of claim 16, wherein the auxetic structure comprises a material with a low Young's modulus (E) and high Poisson's ratio (v).
